(19) United States
(12) Patent Application Publication
(10) Pub. No.: US 2016/0063641 A1
(43) Pub. Date: Mar. 3, 2016

(54) COMPUTERISED METHOD AND SYSTEM FOR PLACING REINSURANCE

(71) Applicant: Guy Carpenter & Company, LLC, NEW YORK, NY (US)

(72) Inventors: Victoria Louise JENKINS, London (GB); Otto Ernst Reinhold BEYER, London (GB)

(21) Appl. No.: 14/837,873

(22) Filed: Aug. 27, 2015

Related U.S. Application Data
(60) Provisional application No. 62/043,703, filed on Aug. 29, 2014.

(51) Int. Cl. G06Q 40/08; G06Q 30/08

(52) U.S. Cl. CPC G06Q 40/08; G06Q 30/08

(57) ABSTRACT

A computerised auction system for enabling auctions of reinsurance placements. A server computer system comprises a processor, memory, auctions database, received bids database, adjusted bids database and administration database. The system communicates on line, or via a private network, with a cedent computer and a plurality of reinsurer computers. Selected reinsurers are invited to participate as bidders in an auction and, when the auction commences, can submit one or more bids in an attempt to secure participation at a price that is the same as or lower than a reserve price. The auction runs in real time and bids are ranked in ascending order of price and, within price, in ascending order of time of receipt. A bidder can enter new bids in an attempt to maintain participation in response to competitive bids from other bidders or in an attempt to increase participation. Each bidder can see the price, participation and rank for their own bids and for competitors' bids. However, a bidder cannot see the identity the owners of competing bids in the auction. A new bid is validated and may be signed down to a lower participation or zero if the total participation of bids for a given bidder exceeds that bidder's maximum permitted participation for the auction, or if the total participation of all bids exceeds the reserve participation for the auction. Progress of the auction is transparent to bidders who can see their bids being signed down and who can submit fresh bids at prices lower than the reserve price.

### FIELD OF THE INVENTION

This invention relates generally to computerised systems for placing reinsurance and insurance risk

### BACKGROUND TO THE INVENTION

The process of reinsurance broking has traditionally been performed in a human-to-human environment and may be divided into various sub-processes including appointment, consulting, placement, reporting and post-placement administration. In the appointment sub-process, the cedent or ceding company, being the party wishing to reinsure a risk, appoints a reinsurance broker to assist in the design of a reinsurance structure and the subsequent placement of that reinsurance structure. Once appointed, a client relationship exists between the cedent and the reinsurance broker.

In the consulting phase, the broker offers various consulting services to the cedent related to the placement of the reinsurance. For Excess of Loss Reinsurance these will include the structuring and layering of the reinsurance programme. An Excess of Loss Reinsurance programme can be sub-divided into a number of layers each of which may be handled separately. As an example, consider a cedent who has estimated in conjunction with the broker that they are exposed to windstorm losses of up to $125 m and that they wish to reinsure (transfer) some of this risk to the reinsurance market. The first $50 million of each and every windstorm loss may be self-insured and, as such, is not placed into the market. The remaining $75 million is divided into three layers of $25 million. A layer is described as having both a limit and a deductible. The limit is the maximum amount of loss passed into the reinsurance market and the deductible is the amount of loss that the windstorm event needs to exceed before any payment from the reinsurers covering the layer is made. In our example the first layer of our $75 m would be described as having a limit of $25 m and a deductible of $50 m (which the cedent is self-insuring), the second layer a limit of $25 m and a deductible of $75 m and the third a limit of $25 m and a deductible of $100 m. Each of these layers will be placed in the reinsurance market and priced individually. The precise structure and layering is determined in consultation with the broker at this initial stage using a combination of catastrophe modelling, actuarial modelling and the broker's market knowledge. The broker will also perform actuarial modelling and catastrophe modelling to determine the technical price (the expected loss cost) and the likely market price of each layer and for the programme in aggregate. Once this is completed, the cedent and the broker will work together to identify a list of target reinsurers to approach with the reinsurance programme.

The likelihood of a given reinsurer being included in the target list will depend on factors such as its credit worthiness, its relationship with the cedent, its business reputation and the appropriateness of its expertise.

The placement process now begins and a subset of the reinsurers on the target list is approached by the broker and asked to provide quotes for the reinsurance layers as presented. A quote is composed of two parts. The first part is the reinsurer's price indication. Alternatively, it may be expressed may be expressed as a percentage of the limit of the layer, in which case it is known as the Rate on Line (RoL) or as a nominal dollar amount. The second part of the quote is an indication of the level of participation (the amount of the layer) that the reinsurer is willing to reinsure at the price that they have indicated and this can be expressed as a percentage of the limit of the layer or as a nominal dollar amount.

The broker may receive multiple and potentially different indicative quotes from the subset of the target reinsurers. However, it is market practice that the reinsurance layer will be placed at a single price. The reinsurer's indicative quotes are used as information in the process of determining what that single price should be. In determining the single price consideration should be given to the price being no higher than necessary to fully place the amount of the layer that the cedent wished to reinsure.

On receipt of the indicative quotes, the broker will collate the quote information and recommend to the cedent an estimated minimum price level per layer at which the agreed reinsurance structure is likely to achieve full placement for each layer. The estimate of the relevant price per layer is based on the modelled price per layer which includes actuarial modelling and catastrophe modelling, the indicative quotes received from the subset of reinsurers, and the broker's expert judgement.

The cedent now sets a firm order single reinsurance premium rate and instructs the broker to release firm order terms (price offered, capacity offered and contract terms & conditions) to the target reinsurers and to place the reinsurance layers at those terms. The broker then approaches the full list of target reinsurers and asks them for their firm offers of reinsurance participation at the single price for the layer. On receipt of these offers of participation the broker calculates the percentage of the layers that have been placed. If the total percentage participation offered by reinsurers exceeds that required by the insurer (the cedent) for a given layer, that layer is said to be over subscribed. Conversely, if the total percentage participation offered by reinsurers is less than required by the cedent for a given layer, that layer is said to be under subscribed. If the layer is undersubscribed there are various options available to the cedent and broker. The cedent may simply decide to self-insure the amount not placed or, if a complete placement is preferred, either the price for the remaining unplaced part of the layer or the price of the complete layer will need to be increased to attract support from reinsurers. If the layer is oversubscribed, the reinsurance broker, in consultation with the cedent, will sign down (reduce) the participation of some reinsurers until the total participation offered equals that required. In the case of over subscription reinsurers may be allocated their full quoted participation, only a part of their quote or none at all. The signing down process is subjective. Once subscriptions have been signed down, the broker confirms the participation allocated to each reinsurer and notifies the reinsurers.

In the example given above, the $125 million reinsurance programme was divided into three layers of reinsurance each of $25 million having respectively, excesses of $50 million, $75 million and $100 million. If one considers the first of these layers, participating reinsurers will in aggregate reimburse the cedent for up to $25 million for that part of the aggregate windstorm loss that exceeds $50 million. The share of the $25 million limit that a particular reinsurer is liable to pay depends on the percentage participation allocated to that reinsurer at the end of the reinsurance placement process.

Consider a situation where the broker releases firm order terms to target reinsurers and requests final participation quotes. The terms state that the price of the layer is a 20% rate on line, the rate on line being defined as the dollar reinsurance premium divided by the dollar limit. This order receives three responses from reinsurers each offering $20 million of cover that is 80% participation each. The placement percentage is therefore 240% ($60 m), comfortably exceeding the $25 m limit of the layer and the three quoted participations need to be signed down. This may be done in a variety of ways, for example, the first could be signed down to 0%, the second to 20% of the limit and the third not signed down at all. Alternatively, the first two reinsurers could be signed down to 40% of the limit each (2×$10 million) and the third down to 20% of the limit ($5 million). Signing down is subjective and there are many signed down permutations. The signing down of individual reinsurers may be based on a variety of factors such as credit-worthiness, the reinsurer's wider relationship with the cedent and the support the reinsurer has provided on other reinsurance layers or programmes. The process of signing-down and the amounts by which individual reinsurers will be signed down is agreed by the cedent in conjunction with the broker and these results are communicated to reinsurers.

The broker will debrief the cedent as to the likely reasons for any over subscription or under subscription, whatever the case may be. Common reasons for under placement are the single firm order reinsurance price being too low or a general lack of capacity in the reinsurance market or both. Common reasons for over placement are the single firm order reinsurance price being too high or a surplus of capacity in the reinsurance market or both.

Following confirmation of the reinsurance placement, the necessary reinsurance contracts will be produced and distributed to the participating reinsurers and to the cedent. The contracts will show the single price at which all participating reinsurers have agreed to participate and the percentage allocation of participation of each of the participating reinsurers. At this stage participating reinsurers have visibility of each other's percentage allocation. The contract is now in place and the reinsurance broker is responsible for administering the payment of reinsurers' premiums from the cedent to the reinsurers as well as administering any reinsurance recoveries should the cedent suffer losses covered by the relevant reinsurance contracts.

Although this traditional model of reinsurance has been in operation for many years, it suffers from a number of significant problems. Both under and over-subscription are problematic although under-subscription is usually seen as a more severe problem from the perspective of both cedent and broker as failure to fill a layer will leave the cedent under-insured. As a result, there is a tendency for brokers to recommend to the cedent a premium rate level that minimises the risk of under-subscription. A very high premium rate could help achieve this aim but at a potentially significant and unacceptable cost to the cedent. In essence, the cedent is offering to pay a higher premium for the reinsurance to ensure that they are completely reinsured. Part of the skill of the broker is to reduce the risk of under-subscription without the cedent suffering a significant and unacceptable cost impact by paying too high a premium for the reinsurance cover.

In view of the risk of under-subscription, it will be understood that rates are set at a level that tends to result in over-subscription. However, over subscription gives rise to problems as does the signing down process.

It will be appreciated from the above discussion that if a reinsurance placement is oversubscribed the cedent benefits as they are able to place the entire reinsurance structure devised with their broker but they may have paid a price which is higher than what could have secured 100% placement. From the reinsurer's perspective some reinsurers are only allocated a fraction of their quoted participation and some may not be allocated any at all. The signing down process is subjective and will be decided as a result of consultation between the broker and the cedent. The broker may recommend to the cedent an appropriate allocation between reinsurers but ultimately the cedent will make a decision as to the appropriate allocation.

Some favoured reinsurers are likely to be allocated a significant part of their quoted participation, if not all of it. The allocation of participation to other reinsurers may vary significantly depending on the degree by which the aggregate quoted participation exceeds the 100% participation required. Thus, in the example given above, if one of the 80% quotes was from a favoured reinsurer the cedent is likely to give the favoured reinsurer their full participation resulting in no participation or very little participation for the remaining two reinsurers. Reinsurers impacted consistently by unfavourable treatment in the signing down process can suffer problems such as a failure to meet business plans and budgets and in extreme cases perhaps even fail to cover their fixed costs due to insufficient premium income. Ideally, there is an equilibrium price where reinsurance market supply precisely meets cedent demand. If the firm order single reinsurance premium rate that has been devised by the broker attracts a quoted participation that significantly exceeds the participation that the cedent requires, the cedent may argue that the brokers rate recommendation was wrong and not aggressive enough. The cedent would argue that the broker could achieve a lower reinsurance premium rate and still have been able to fully place the layer of reinsurance. As a result, the cedent is left paying higher premiums than they think are necessary. However, the traditional process described does not allow the single reinsurance premium rate to be varied once firm order terms have been sent to the market by the broker, unless a re-pricing exercise is needed due to under subscription. While this is clearly disadvantageous for the cedent, who pays higher premiums than necessary, it is also disadvantageous for large parts of the reinsurance market. Inflexible pricing means that reinsurers have little or no control over their allocated participation percentage. A reinsurer cannot offer a premium rate below the firm order premium rate to secure a better allocation and is therefore barred from offering a better rate which could benefit the cedent whilst giving the reinsurer more control over its likely participation allocation. The subjectivity of the signing down process clearly suffers from a lack of transparency, is disconnected from the price and does not necessarily result in an optimal allocation or an optimal price. For reinsurers, it is difficult to assess whether they should participate in a placement as the attractiveness of a particular rate can depend on the percentage they are allocated. A reinsurer who sees a given rate as being good business at a high participation rate and bad business at a low participation rate may decline to participate if they believe that there is a high likelihood of being signed down and thereby forced to accept poor quality business.

The equilibrium price described above can change over time and typically moves through cycles of high prices indicating hard markets and low prices indicating soft markets. Regardless of whether the reinsurance marketplace is hard or soft at a given time, the issue of significant under or over subscription and the inability of the single price and the signing down process to identify the equilibrium price remains a valid concern. Reinsurers compete for market allocation in both markets although competition may be less fierce in hard markets around a higher equilibrium price with a smaller supply of reinsurance capacity and more fierce in soft markets around a low equilibrium price with a higher supply of reinsurance capacity.

### SUMMARY OF THE INVENTION

The invention aims to address the problems identified in the signing down process and the single price at which reinsurance is transacted.

According to the invention there is provided a computerised method of auctioning reinsurance capacity. The method is performed by an auction server computer system communicating with a cedent computer and a plurality of bidder computers via a communications network, the server computer system comprising a processor, a memory, a received bids database, an auctions database, an adjusted bids database and an administration database. At the server computer system bids are received from bidder computers to participate in a reinsurance auction, the auction having a predetermined reserve price and reserve quantity and each bid comprising a bid price and a bid quantity at that price. The received bids are validated at the server computer system and the validated bids are stored in the received bids database and also the adjusted bids database of the computer system in order of time of receipt. For each received bid the system compares the sum of quantities of prior received bids and the received bid with the reserve quantity of the auction. If the sum of quantities is greater than the reserve quantity, the quantity of one or more of the received bids and prior received bids is signed down according to a price priority and, for each price, according to a time of receipt priority so that the sum of quantities of the prior received bids and the received bid is equal to the reserve quantity. After the comparison, the quantity of signed down received or prior received bids is overwritten in the adjusted bids database. At the end of the auction, reinsurance contracts are concluded with bids remaining in the adjusted bids database.

The invention also resides in a computerised auction system for auctioning reinsurance capacity. The auction system comprises a server computer system and program code running on the server computer system, the server computer system communicating with a cedent computer and a plurality of bidder computers via a communications network. The server computer system comprises a processor; a memory; a received bids database; an auctions database; an adjusted bids database; and an administration database. The program code, when executed on the processor causes the server computer system to receive bids from said bidder computers to participate in a reinsurance auction, the auction having a predetermined reserve price and reserve quantity and each bid comprising a bid price and a bid quantity at that price. The program code causes the computer system to validate the received bids and to store validated bids in the received bids database and in the adjusted bids database of the computer system in order of time of receipt. The program code causes the computer system, for each received bid, to compare the sum of quantities of prior received bids and the received bid with the reserve quantity of the auction. If the sum of quantities is greater than the reserve quantity, the code causes the system to sign down the quantity of one or more of the received bids and prior received bids according to a price priority and, for each price, according to a time of receipt priority so that the sum of quantities of the prior received bids and the received bid is equal to the reserve quantity. After the step of comparing, the code causes the computer system to overwrite the quantity of signed down received or prior received bids in the adjusted bids database. At the end of the auction, reinsurance contracts are concluded according to bids remaining in the adjusted bids database.

Embodiments of the invention have the advantage that bids for reinsurance contracts can be submitted into an on-line system which is transparent and in which the price is allowed to vary by reinsurer. Thus the market can come to equilibrium as higher priced bids are signed down. Participants can submit multiple bids during the course of the auction as they see their higher priced bids being signed down to zero.

Preferably, the step of signing down bids in the adjusted bids database comprises removing from the said adjusted bids database any bid having a signed down participation of zero. Preferably, the step of storing a signed down bid in the adjusted bids database comprises removing the bid from the database if the signed down participation of the bid is zero.

Preferably, prior to the step of receiving bids, an invitation is sent to selected bidder computers to participate in a forthcoming auction, the invitation identifying the reinsurance contract to be auctioned and the start time of the auction. In this manner the cedent can control who takes part in the auction. Preferably, an acceptance of the invitation to participate in the forthcoming auction is received from one or more bidder computers. Once a bidder has accepted an invitation and the auction has commenced, preferably details of live bids stored in the adjusted bids database including the price and participation of bids are periodically sent to participating bidder computers for display.

Preferably, the details of live bids include the position in a queue for each displayed bid, the queue comprising bids at the same price and being ranked in order of time or receipt of the bid at the auction server computer. Preferably the details of the live bids sent for display are anonymous as to the identity of the bidder submitting the bid.

Preferably, each bidder has a pre-determined maximum quantity biddable in the auction. The sum of quantities of the bidder's prior bids and the received bid may be compared with the maximum quantity, and if the sum of quantities of the received bid and the bidder's prior bids is greater than the maximum quantity, the bid quantity of one or more of the prior bids or the received bid is signed down so that the sum of quantities for all of the bidder's bids is equal to the maximum quantity, bids being signed down according to a price priority and, for each price, according to a time of receipt priority.

In one embodiment each bidder has a pre-determined maximum quantity biddable in the auction, and a pre-determined maximum quantity biddable in an auction program comprising a plurality of auctions including the auction, comprising comparing the sum of quantities of the bidder's prior bids in the auction and the received bid with the maximum auction quantity, comparing the sum of quantities of the bidder's prior bids in auctions comprising the auction program, and if the sum of quantities of the received bid and the bidder's prior bids is greater than the auction maximum quantity or the sum of the quantities of the prior bids in auctions comprising the auction program and the received bid is greater than the maximum quantity biddable in the auction program, signing down the bid quantity of one or more of the prior bids or the received bid so that the sum of quantities for all of the bidder's bids is equal to the maximum auction quantity and the maximum auction program quantity, bids being signed down according to a price priority and, for each price, according to a time of receipt priority.

The setting of a maximum participation for a program of auctions enables the cedent to control counterparty credit risk exposure across more than one auction.

Preferably, the termination time of the auction is variable between an earliest auction close time and a latest auction close time, the actual close time being determined by the auction server computer. Preferably the earliest auction close time and the latest auction close time are communicated to bidder computers for display. This has the advantage that bidders are encouraged away from submitting bids right at the end of the auction as they are not certain when the auction will close. This in turn has the advantage of ensuring that the auction is transparent and has the greatest chance of finding the equilibrium price.

In one embodiment the auction server computer retrieves a list of live auctions from the auctions database, selects an auction from the auction database, determines whether a next time for testing whether the selected auction can be closed, has been reached, the next time for testing being set initially to the earliest auction close time, if the next time for testing has been reached, choosing a random close time between the earliest auction close time and the latest auction close time, determining whether that random close time is in the past and, if it is in the past, closing the auction. If the random close time is determined not to be in the past, setting the next time for testing as another random time between the earliest auction close time and the latest auction close time. The process may then determine whether the list of live auctions includes any further auctions and, if there are further live auctions, select a further auction from the live auction database. If there are no further live auctions, the process may wait for a predetermined period of time and then retrieving a list of live auctions from the auctions database.

Preferably, multiple bids are allowed from a bidder during an auction. Preferably, a bid received from a bidder is binding on the bidder. Preferably bids may be amended, an amended bid having one or both or a lower price and a greater participation than the original bid.

Preferably, after storing the one or more signed down bids in the adjusted bids database, a determination is made from the bids stored in the adjusted bids database whether the sum of quantities for bids at or below a given price is equal to the reserve quantity and if so, the reserve price for the auction is updated. The updated reserve price may be equal to the lowest price having the sum of quantities for bids at or below that price equal to the reserve quantity, less the predetermined price increment.

Preferably, validating bids comprises determining whether the bid price is less than or equal to the reserve price and notifying the bidder if the bid price is not less than or equal to the reserve price. Preferably, after validation of a bid, the bid is stored in the received bids database and the adjusted bids database, wherein the step of storing the signed down bid in the adjusted bids database comprises replacing the received bid in the adjusted bids database with the signed down bid.

In one preferred embodiment, comparing the sum of quantities for the bidder's prior bids and the received bid with the bidder's maximum quantity comprises the processor querying the auctions database to return the maximum quantity for the bidder in the auction. The returned maximum quantity is stored in a memory of the server computer system and the adjusted bids database queried to return the sum of all prior bids from the bidder for the auction at the same or better prices. The returned sum of all prior bids is stored in the memory and the stored sum of all prior bids' quantity and the bid quantity is summed by the processor and a determination made whether the sum is greater than said maximum quantity. If said sum is greater, the processor signs down the bid quantity of one or more of the prior bids or the received bid so that the sum of quantities for all of the bidder's bids is equal to the maximum quantity. Bids are signed down according to a price priority and, for each price, according to a time of receipt priority. Bids having signed down quantities equal to zero are deleted from the adjusted bids database; the signed down quantities for bids having signed down quantities is greater than zero are overwritten in the adjusted bids database.

Preferably the processor notifies the bidder computer if a bid is deleted or signed down. This enables the bidder to submit a fresh bid at a better price.

In a preferred embodiment, comparing the sum of quantities of the prior bids and the received bid with the auction's reserve quantity of the auction comprises the processor querying the auctions database to return the reserve quantity and storing the returned reserve quantity in said memory. Signing down the bid quantity may comprise querying the adjusted bids database to return the sum of quantities for all prior bids in the auction and storing the sum returned in said memory; determining whether the sum of quantities for all prior bids and the received bid is greater than the reserve quantity; and if the sum is greater, signing down the quantity of one or more bids so that the sum of quantities is equal to the reserve quantity. Bids may be signed down according to a price priority and, for each price, according to a time of receipt priority.

Preferably, after storing the signed down bids in the adjusted bids database, bid records are sorted in ascending order of price and, within price, in ascending order of time of receipt at the server computer system.

### BRIEF DESCRIPTION OF DRAWINGS

Embodiments of the invention will now be described, by way of example only, and with reference to the accompanying drawings in which:

FIG. 1 is a schematic representation of the known reinsurance placement process described above;

FIG. 2 is a schematic representation of the modified reinsurance placement process embodying the present invention;

FIG. 3 is a flowchart illustrating an embodiment of the present invention;

FIG. 4 is a block diagram showing the major components in the system;

FIG. 5 is a screen shot of a bidder's screen during an auction;

FIG. 6 is a schematic view of the major processes involved in forthcoming, current and completed auctions;

FIG. 7 is a schematic view of an entity and user registration process in an embodiment of the present invention;

FIG. 8 is a process diagram showing the interactions between the underlying computer system of FIG. 4 and the process of FIG. 3;

FIG. 9 is a flow chart showing the steps in an end of auction process; and

FIG. 10 is a flow chart showing the steps in an alternative embodiment of the maximum auction participation process.

### DESCRIPTION OF PREFERRED EMBODIMENTS

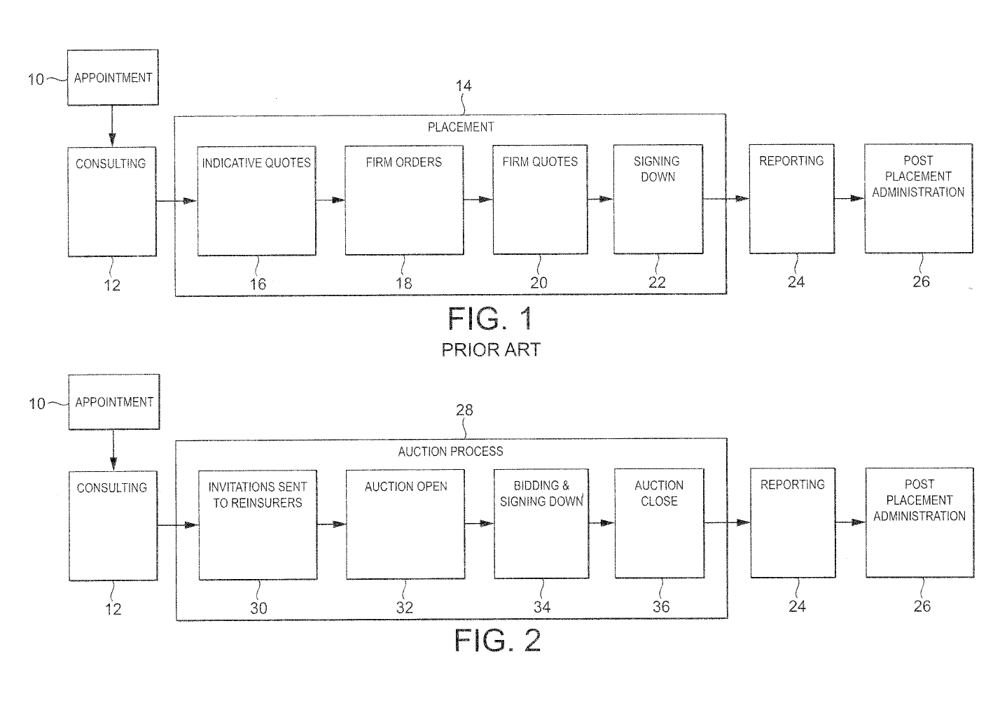

FIG. 1 is a schematic representation of the reinsurance placement process in the prior art approach described above. The reinsurance placement process is divided into a number of sequential sub-processes: appointment 10, consulting 12, placement 14, reporting 24 and post-placement administration 26. The placement sub-process comprises reinsurers submitting indicative quotes 16, the cedent ordering the broker to release firm order terms 18, reinsurers replying with firm order quotes 20 and finally the cedent signing down 22 the firm quotes in a subjective manner.

FIG. 2 outlines schematically an alternative version adopted in an embodiment of the present invention. The appointment, consulting, reporting and post-placement administration sub-processes are similar to those described above. However, rather than establish a single price which is communicated to a shortlist of reinsurers through firm order terms, a system embodying the present invention establishes a list of reinsurers that are invited 30 to bid for participation of the layer to be placed in a competitive real time auction environment. Thus, the layer is placed by an auction process 28 which commences when the auction is opened at 32, receives bids and signs down bids electronically at 34 on a price-time priority basis and then closes at 36. In some embodiments the signing down may be performed in real time In contrast, in the prior art method described above, there is a single price for all reinsurers, a single round of firm order quotes and a subjective signing down mechanism.

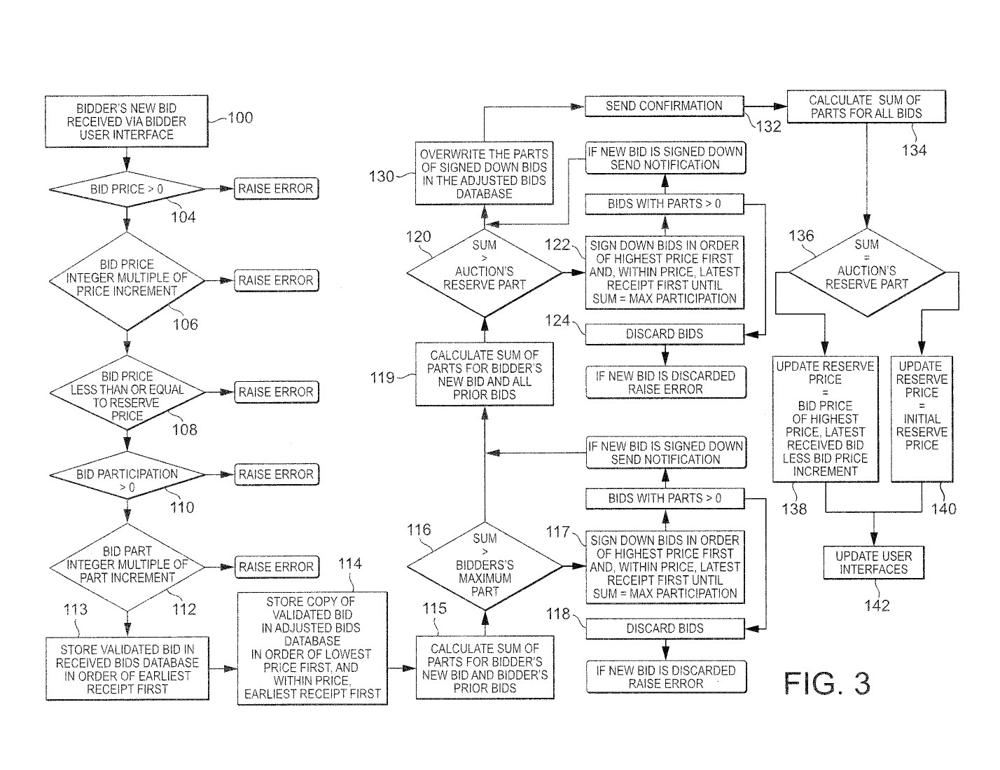

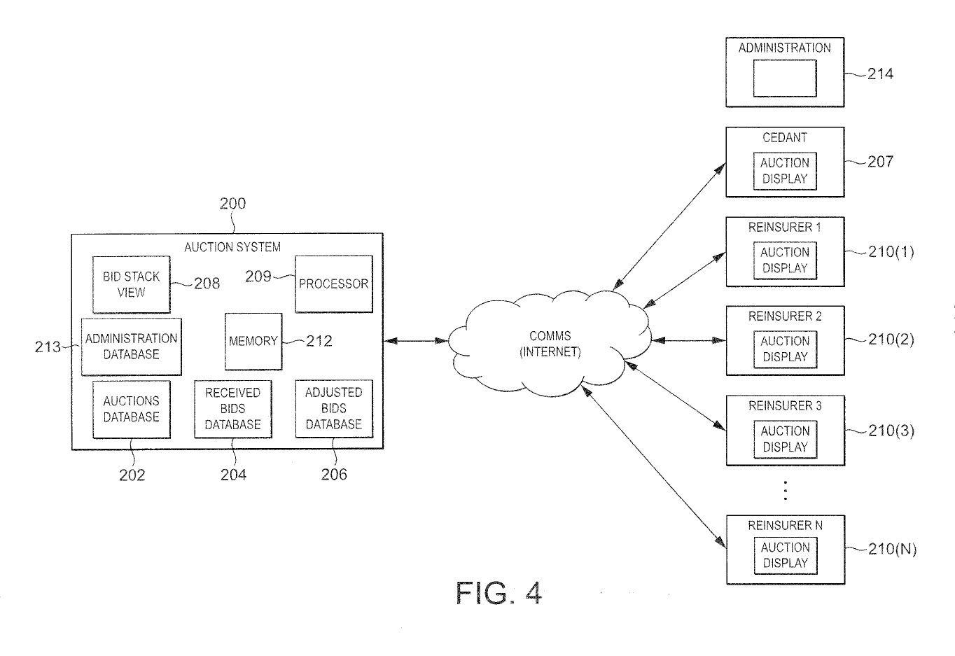

FIG. 3 illustrates, at a high level, the auction algorithm which is run on the system illustrated schematically at a high level in FIG. 4. In FIG. 4 the auction system is illustrated generally at 200. The auction system may comprise a software application running on a general purpose server computer including a processor 209 which executes the application, memory 212, a received bids database 204, an adjusted bids database 206, an auctions database 202 and an administration database 213. The databases 204, 206, 202 and 213 may be separate databases or logically separate areas of the same data repository, for example different tables within a database, or a combination of the two. The system also provides, through a conventional display or otherwise, a bid stack view 208 enabling users to view the live bids in an auction, for example in order of ascending price and, within price, ascending time of receipt. The auction system is accessed by, and communicates with, the cedent 207, and administrator user 214 and a plurality of reinsurers 210 (1) to 210(N). Although shown separately, the cedent in one auction may be the reinsurer in another auction. The cedent and reinsurers communicate with the auction system via a communications network such as the Internet although other possibilities such as a private network are possible. The cedent 207 and the reinsurers 210 (1) to 210(N) each comprise one or more computer terminals which include a display for displaying auction information to users as well as a processor and input/output devices for receiving, processing and transmitting messages related to auctions to and from the auction system 200. Rather than comprising an individual computer, a reinsurer entity may have a network of computers communicating with the auction system. In such a network, one computer will act as the administrator computer for the reinsurer.

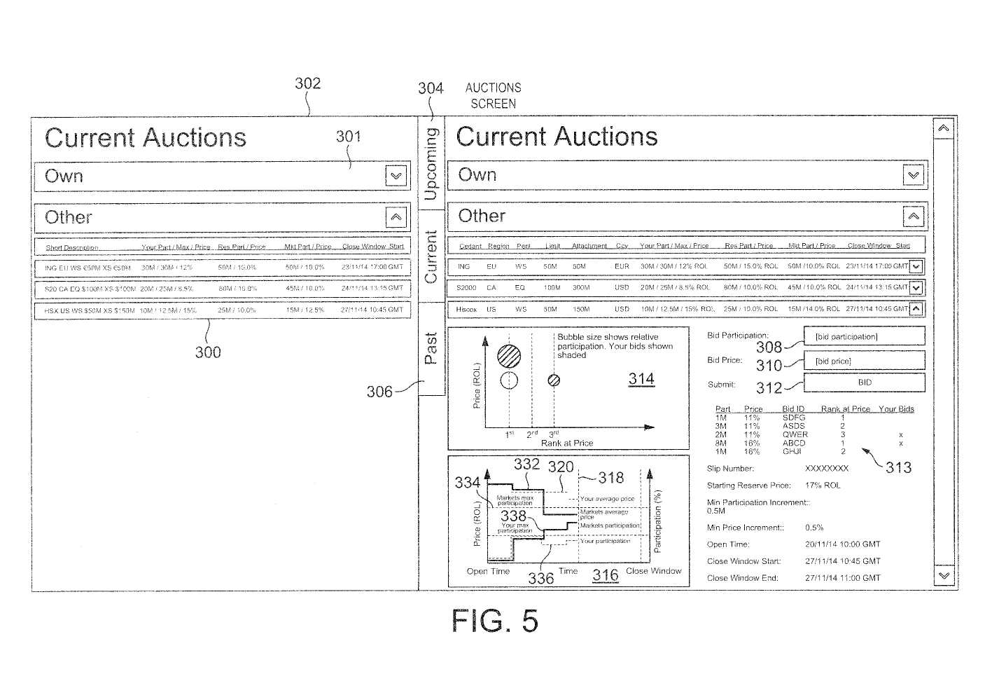

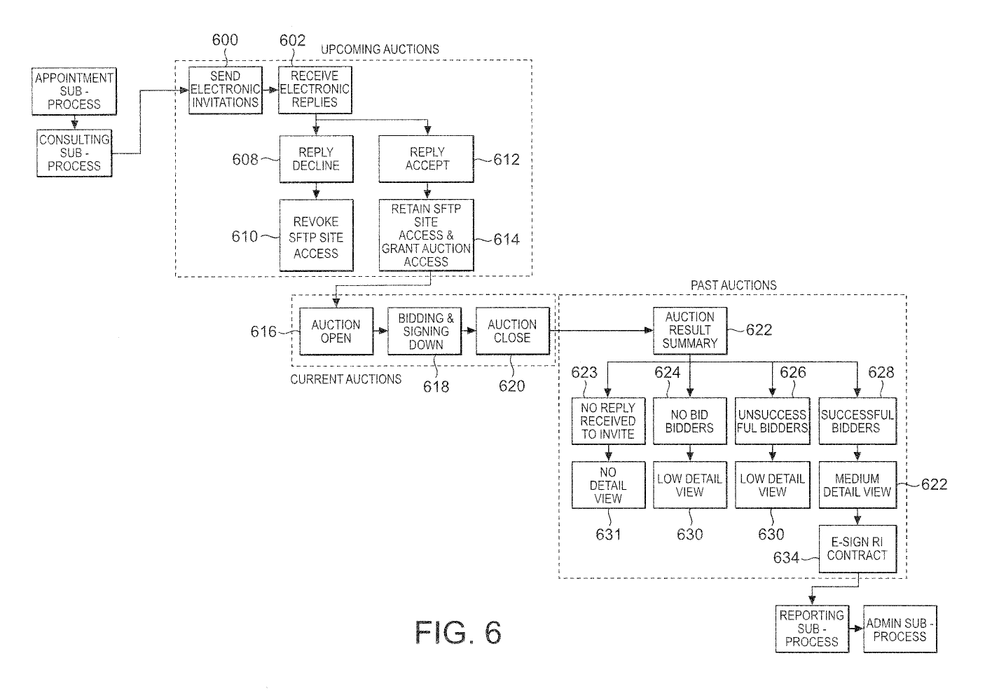

Returning to FIG. 3, the process illustrated commences once the cedent and broker have established a new auction and sent invitations to possible participants. This process will be described with relation to FIGS. 5 and 6.

A reinsurer who responds to an auction invitation by submitting a new bid is referred to as a bidder. At step 100 a bidder submits an electronic bid via the communications network that is received by the auction system 200. The bid includes a bid price, a bid quantity at that price, a bidder identification number and a randomly generated bid number. The bid number is a unique serial number that enables a bid to be uniquely identified. The bid price may be expressed as RoL which, as described above, is a percentage of the value of cover that is being placed. The bid quantity may be expressed as a participation which, in turn may be expressed, for example, as a percentage of the full limit of cover or as a nominal dollar amount. For example, for a limit of cover of $50 million above an attachment point (excess) of $150 million, a bid price of 12.5% implies a reinsurance premium of $6.25 million for the full $50 million limit of cover. A participation of 10% with an RoL of 12.5% indicates that the bidder is offering a $5 million limit of cover (10% of the $50 million) in return for a premium of $65,000 ($50 m×12.5%×10%). A reinsurer is said to participate on a reinsurance contract if the limit of cover provided is greater than zero. At step 113, the bid is stored in the received bids database 204 and the database is sorted in ascending order of submission time together with the details of the bid; price, quantity, bidder and number. The algorithm to be described is applied to all bids that are entered into the system as soon as they are stored in the received bids database 204.

At steps 104 to 112, a submitted bid is subjected to one or more validation tests. At step 104 the bid price is tested to confirm whether or not it is greater than zero. If this test is passed, at step 106 the bid price is tested to confirm whether or not it is an integer multiple of a pre-determined price increment that the system will accept. If this test is passed, at step 108, the bid price is tested to confirm whether or not it is less than or equal to the reserve price. The reserve price is agreed between the broker and the cedent before the auction but, as is explained below, is not fixed throughout the auction unlike in the prior art described above. A lower price submitted by a bidder is therefore a more aggressive bid. If the bid price is lower than the reserve price the bid participation is tested at step 110 to confirm whether or not it is greater than zero. If this test is passed, at step 112, the bid participation is tested to confirm whether or not it is an integer multiple of the pre-determined participation increment.

If the new bid fails any of tests in steps 104 to 112, the bid is rejected and does not participate in the auction. The system 200 raises an error and sends a message to the terminal 210 informing the bidder that the bid has been rejected as well as the reason for the bid's rejection. Not all of the tests are essential and, for example, alternative embodiments may permit bid prices or quantities be they expressed as participations or otherwise that are not integer multiples of the price increment or participation or other quantity increments respectively and so steps 106 and 112 may be omitted.

In the next stage of the process, the algorithm applies rules for a bidder-specific maximum participation restriction and overall reserve participation restriction. The cedent sets these restrictions in advance of the auction and informs the bidder that the restriction will be enforced. This way the cedent can control their credit risk exposure to any one bidder and the bidder is aware of their own participation restriction in addition to the overall participation requirement. Different bidders may be allocated different participation restrictions based on factors described earlier in this document. For example, the cedent may decide that one bidder may only bid for up to a 20% participation whilst another may bid for up to an 80% participation as a result of differences in creditworthiness. The algorithm enforces these restrictions by, if necessary, signing down the participations of bids in the adjusted bids database until the sum total of participation equals the bidder-specific maximum participation restriction or the overall reserve participation restriction respectively. Bids are signed down in descending order of price, and within price, descending order of time received.

First, the algorithm enforces the bidder-specific maximum participation restriction. At step 114 a copy of the validated bid is stored in the adjusted bids database, preferably, in order of lowest price first and, within price, earliest receipt first. At step 115 the algorithm calculates the sum of participations for the bidder's new bid and prior bids stored in the adjusted bids database. At step 116, the algorithm compares the said sum with the bidder's maximum participation. If the sum is less than or equal to the restriction then no bid participations need to be signed down since the bidder has submitted a new bid that is within the bidder-specific maximum participation restriction. If the sum is greater than the restriction then bid participations are signed down at step 117 until the total participation for the bidder is equal to the maximum participation. Bids are signed down in order of highest price first and, within price, latest time of receipt first until the maximum participation is reached. Bids that are signed down to zero are discarded from the adjusted bids database at step 118. If the new bid is among the discarded bids then the system raises an error and sends a message to the bidder informing them that the bid has been rejected as a result of the bidder's maximum participation restriction. The bidder may then choose to submit another bid at a different price later. If the participation of the new bid has been signed down to a value greater than zero then the system sends a notification to the bidder informing them that the new bid will be signed down if they choose to proceed with submitting the bid. The bidder may then choose to either continue to submit the new bid or to cancel the bid and perhaps enter another bid at a different price later.

If the new bid has not been signed down, or if the new bid has been signed down to a value greater than zero, then bid processing continues.

Second, the algorithm enforces the overall reserve participation restriction. At step 119, the algorithm calculates the sum of participations for the new bid and all prior bids stored in the adjusted bids database. At step 120, the algorithm compares the said sum with the auction's reserve participation. If the sum is less than or equal to the restriction then no bid participations need to be signed down since the bidder has submitted a new bid that is within the auction's reserve participation restriction. If the sum is greater than the restriction then bid participations are signed down at step 122 until the total participation for all bidders is equal to the reserve participation. Signing down is again performed on the bids in order of highest price first and then, within price, time of receipt at the system until the maximum participation is reached. Bids that are signed down to zero are discarded from the adjusted bids database at step 124. If the new bid is among the discarded bids then the system raises an error and sends a message to the bidder informing them that the bid has been rejected as a result of the auction's reserve participation restriction. The bidder may then choose to submit another bid at a different price later. If the participation of the new bid has been signed down to a value greater than zero then the system sends a notification to the bidder informing them that the new bid will be signed down if they choose to proceed with submitting the bid. The bidder may then choose to either continue to submit the new bid or to cancel the bid and perhaps enter another bid at a different price later.

After the algorithm has applied the participation restriction rules, and assuming that the new bid has not been rejected and that the bidder has decided to proceed with submitting the new bid following a signing down notification, the algorithm overwrites the participations of signed down bids in the adjusted bids database at step 130.

At this stage the bidder has submitted a valid new bid and, if necessary, the bid has been appropriately signed down along with the prior bids at prices lower than the new bid price. The system sends a confirmation to the bidder at step 132 informing them that their new bid has been successfully submitted.

At step 134, the algorithm calculates the sum of participations for the new bid and all prior bids stored in the adjusted bids database after the algorithm of the participation restriction rules. If the algorithm enforced the overall reserve participation restriction then the sum of participations will be equal to the reserve participation. Otherwise the sum of participations will be less than or equal to the reserve price. At step 136, the sum is compared to the reserve participation. If the sum is equal to the reserve participation then, as shown at 138, the reserve price is updated and set equal to the bid price of the highest priced and most recently submitted bid in the adjusted bids database less the pre-determined bid price increment. Otherwise, as shown at 140, the reserve price remains unchanged and equal to the pre-determined initial reserve price for the auction.

Finally, the algorithm updates the various user interfaces; the system operator interface, the bidder interface and the cedent interface. The algorithm has completed its processing of the new bid and is ready to accept the next bid any of the auction's bidders.

The following example illustrates the reserve price updating process.

Consider an initial reserve price that is set at 20% and an initial reserve participation that is set at 100% at the start of the auction. A new bid at a price higher than 20% will not be allocated any participation for the reinsurance contract that is being auctioned. Consider then the position where the sum total of participations across all bids in the adjusted bids database is 100% and the highest bid price in the adjusted bids database is 16%. A new bid at a price higher than or equal to 16% will not be allocated any participation as a result of the overall reserve participation restriction. The highest price at which the bidder is able to secure any participation is 15.50%, the highest bid price in the adjusted bids database 16% less the pre-determined bid price increment 0.5%. Thus, the reserve price is 15.50%. The reserve price will either stay the same or reduce during the course of the auction, but cannot increase.

Following the application of the participation restriction rules and the update to the reserve price, the system 200 uses the adjusted bids database and the updated reserve price to produce summary information which is then communicated to the auction system and displayed in the relevant user interfaces. The summary information provided to the system operator shows the current allocation of participation amongst bidders and the weighted average price bid by each bidder. The system operator has full visibility of all bids as well as the identity of all bidders. The summary information provided to the bidder is their own current allocation of participation and their own weighted average price. The bidder has full visibility of their own bids and the bids of others, price and participation. However, the identities of other bidders are withheld. The summary information provided to the cedent is the same as for the bidder except that the cedent cannot submit any bids.

Thus, as an auction progresses, bidders can see how their bids are progressing. They can see the reserve price moving lower over time and their earlier bids being signed down either partially or completely in response. Bidders are able to submit fresh bids into the system in order to maintain or increase participation. In contrast to the prior art system, the price discovery process is transparent and will tend to an equilibrium price where the forces of supply and demand are balanced. Moreover, the problems with signing down of orders discussed above are avoided as participants see when their participation has been signed down and can increase their participation by submitting fresh orders at lower prices.

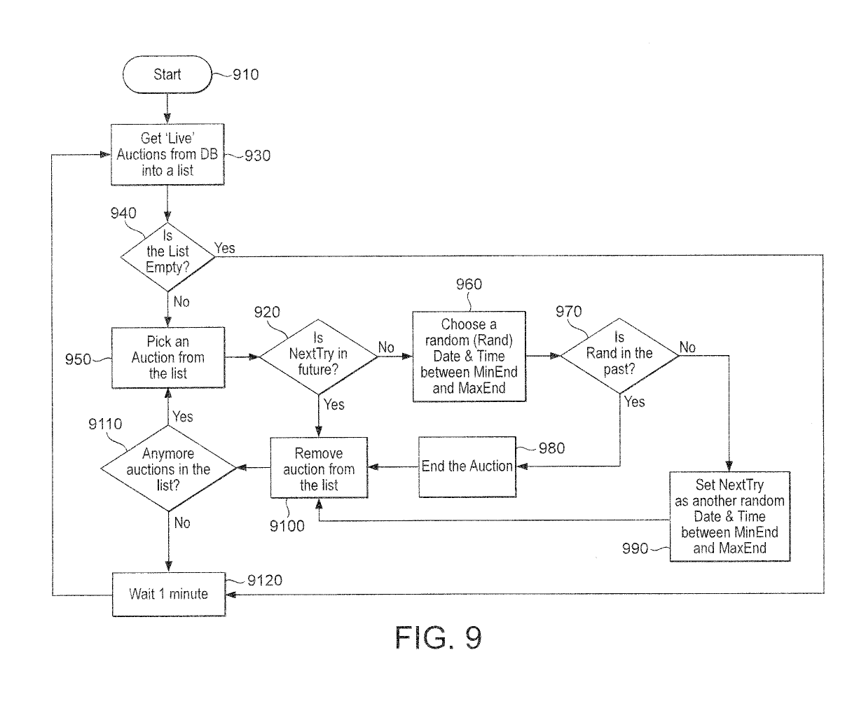

FIG. 5 shows an auction display screen which is displayed on a user terminal 210. The user, whether cedent or bidder, interfaces with the system through this display. The user can select between their own (cedent) auctions and those initiated by others and can choose between upcoming, current and past auctions and can also select between invitations accepted, pending and declined. In the example FIG. 5, the display shows three auctions in which the user is participating as a bidder, the bids being displayed in a list 300 on the left hand side of the display, the list identifying the auction by a unique market reference (UMR) number as well as a short description of the identity of the cedent, the location of the risk to be reinsured, the peril to be reinsured and the layer to which the auction relates. Thus, the bottom-most auction identifies the auction as company HSX seeking reinsurance cover for a single layer of $50 million with an attachment point of $150 million for US Windstorm. Also shown is the bidder's current participation, their maximum participation restriction and their weighted average price bid ($10 m, $12.5 m and 15% RoL) together with the reserve participation and current reserve price ($25 m and 10% RoL) and the current market participation and weighted average market price ($15 m and 12.5% RoL). Also shown is the time at which the window close commences. In order to discourage market participants from entering bids at the very last minute, the system defines a period, typically in the order of 15 minutes, during which the window, that is the auction, will close. The actual close time will be chosen randomly from within this window. The earliest and latest close times are displayed to the user. This process is discussed in more detail below in conjunction with FIG. 9.

As can be seen from FIG. 5, the user can select from current auctions 302, upcoming auctions 304 and past auctions 306. The ability to look at past auctions ensures that the user can view information regarding completed auctions. The ability to see upcoming auctions enables the user to consider whether or not they want to take part in future auctions.

In FIG. 5, the bidder has selected the bottom most auction which is a current auction for which they accepted an invitation to participate. In the bottom right hand quarter of the display is shown details relating to that auction, including the UMR number, the starting reserve price, the minimum participation and price increments, the opening time for the auction and the start and end times for the window close. At the right hand side is a bid price entry window 308, a bid participation entry window 310 and a bid submit button 312. The bidder uses the windows 308 and 310 to enter the price and participation for a new bid and the button 312 to submit that bid to the system.

Underneath the bid entry area is a bid stack 313 which comprises list of all the bids that are presently in the system for the selected auction. This listing does not show bids which have been signed down to zero. For each bid there is shown the price, the participation and the bid identity, but not the identity of the bidder. Additionally there is shown the rank of that bid at the particular price point and an indication of whether or not the bid is the bidder's own bid (highlighted bids are the bidder's own bids).

A bid's rank at a given price point is determined using time priority so that the earliest bid received at the auction system 200 at a given price has priority. This again encourages early submission of bids which in turn assists in the market coming to equilibrium during the auction process.

In the example of FIG. 5, the bidder has submitted two bids, one for a $2 million participation at 11% RoL which is ranked third at that price, and one for an $8 million participation at 16% RoL which is ranked first at that price.

Beneath the bid stack 313 is displayed the slip number, the starting reserve price, the minimum participation and price increments, the opening time for the auction and the start and end times for the window close.

To the left of the bid stack are two graphical displays of the auction. These both enable the bidder to view the state of the auction easily to determine the quality of their bids and the likelihood of the participant being successful.

The uppermost visual display area 314 is a bubble chart graph of rank at price on the horizontal axis against price (RoL) on the vertical axis. Each bid is shown as a bubble or circle, the area of which shows the relative participation. The example of FIG. 5 shows three bids with the bidder's bids being shown in a different colour from competitors' bids. The bidder can click on the display area to enlarge the graph to a full screen display which will populate the graph with all of the bids for the auction. In the reduced view visible in FIG. 5, the bidder's own bids are shown and, where those bids are not first ranked, the first ranked bid at that price is shown. Thus, in the first rank, the uppermost bid equates to the bidder's $8 million at 16%. The third rank shows the bidder's $2 million at 11% and the best bid at that price is shown in the first rank.

The lowermost display area is a line chart visual display area 316, which can also be enlarged to full screen by clicking anywhere within the display area, shows a graph of time on the horizontal axis against price (RoL) on the primary vertical axis and participation on the secondary vertical axis. Time extends from the auction open time to the close window. The current point in time is shown as vertical dashed line 318.

In the upper part of the display there is displayed the bidders weighted average price across time as a horizontal dashed line 320 and the market weighted average price 322 across time. This weighted market average price is the average price of all users on the system. Thus is can be seen that the bidders weighted average price has fallen slightly but the weighted market average price has fallen more substantially suggesting that the bidders average price is too high compared to the rest of the market. This allows the bidder to compare their current and historic price bid during the auction against the current and historic market weighted average price bid during the auction.

The line chart also displays the bidder's total participation bid across time as dashed line 334 as well as the total market participation bid across time as solid line 338. Horizontal line 334 indicates maximum market participation. This allows the bidder to compare their current and historic participation bid during the auction against the current and historic

FIG. 6 shows the placement process for upcoming, current and past auctions. The system may be used by invitation only and the application is not visible to unregistered parties. The major processes involved in forthcoming, current and completed auctions are shown.

In FIG. 6, following the appointment and consulting sub-processes, the auctioneer sets up a new auction in the auction system 200. The auction details and parameters are stored in the auctions database 202. Typical details would include a unique market reference number for the auction, the cedent name, region, peril, attachment point and limit. Typical parameters would include the reserve participation, initial reserve price, participation increment, price increment and each invitee's maximum participation restriction. A list of system users is stored in the administration database 213 and the cedent will direct the auctioneer to send invitations to a subset of reinsurers on the list, inviting them to participate in the auction. At step 600 the system sends electronic invitations and, at step 602, checks whether or not replies have been received from the invitees. If a given invitee declines an invitation at step 608, then access to the SFTP site is revoked at step 610 which prevents the bidder from accessing any of the supporting documentation and data relating to the layer of reinsurance that is being auctioned. If a given invitee accepts an invitation at step 612, the access to the SFTP site is retained and access to the upcoming auction is granted 614 so the bidder can participate in the auction once it opens.

Once an auction is open it is referred to as being a current auction. The auction is shown as open at step 616 following which live bidding and signing down takes place at step 618 and the auction closes at step 620. The application calculates summary results for each past auction at step 622. However, not all users have the same level of access to the summary results. The auctioneer and the cedent can view the highest level of detail for summary results calculated for the auction. If an invitee neither accepted nor declined their invitation by the end of the auction at step 623, then they are not allowed to view any summary results calculated for the auction at all at step 631. If an invitee accepted their invitation but did not manage to enter any bids during the auction, or did not manage to submit any successful bids by the end of the auction at step 626, then they are allowed to view a low level of detail for summary results calculated by the auction at step 630. In particular they will be allowed to view the history for the auction, the reserve price at the end of the auction, the total amount of participation placed and the weighted average price for the placement. They are not allowed to view the identity of other successful bidders, nor the allocated participation of each, nor the weighted average price bid by each. If an invitee accepted their invitation and managed to submit at least one successful bid by the end of the auction at step 628, then they are allowed to view a medium level of detail for summary results calculated by the auction at step 632. In addition to the low level of detail visible to other bidders, successful bidders are allowed to view the identity of other successful bidders as well as the allocated participation of each. They are not allowed to view the weighted average price bid by other successful bidders. Successful bidders then electronically sign the reinsurance contract at step 634 and the process passes to the reporting and administration processes which are essentially the same as used in the prior art process.

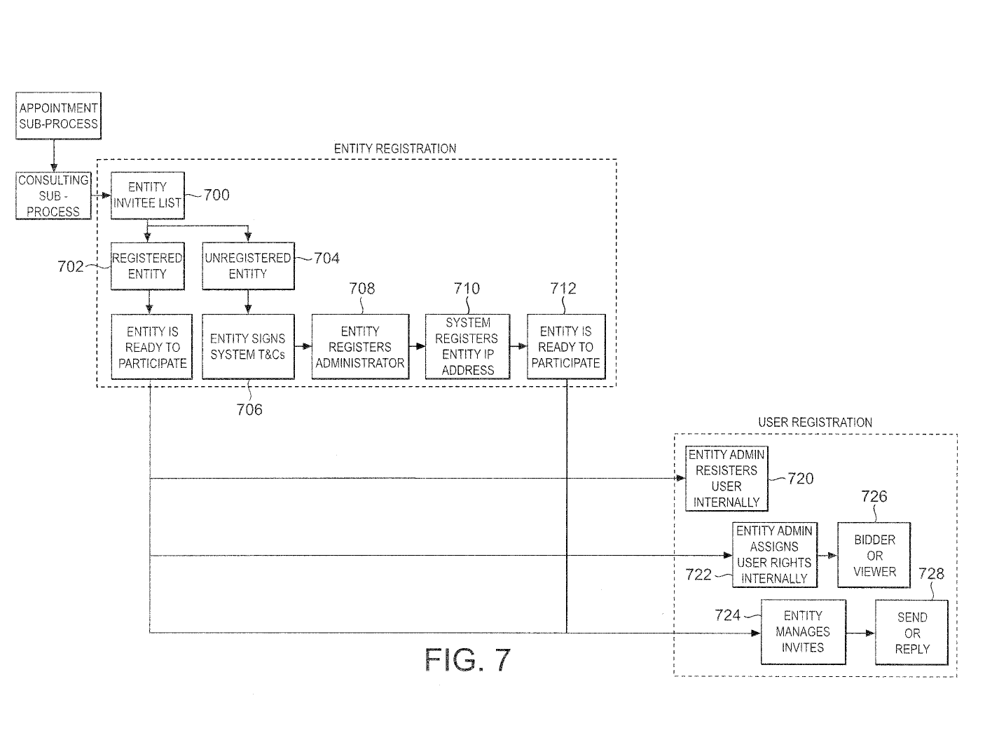

The entity and user registration process in an embodiment of the present invention is shown in FIG. 7. Reinsurance entities are registered to use the application on a one-off basis and each entity appoints an in-house administrator that registers its own users and assigns user rights to its users internally.

In FIG. 7, following the appointment and consultation sub-processes, a list of entities to be invited is agreed between the cedent and the broker. The entity invitee list is shown as 700. Some entities may already be registered 702. For an unregistered entity 704 it is required that they are registered on to the auction system to enable them to use the system. This requires the entity to sign the system terms and conditions at step 706, to assign a responsible person from the entity to act as the its administrator at step 708 and to register the entity's IP (internet protocol) address with the auctioneer at step 710. The entity's administrator will be responsible for registering its own users at step 720, assign user rights to its own users at step 722 as well as sending and accepting auction invitations at step 724. The rights may be full rights enabling a user to enter bids onto a system or simply viewing rights enabling a user to follow an auction at step 726. Viewing rights may be appropriate where the user is the cedent and therefore has an interest in viewing progression of the auction but not in entering bids. Once registered, the entity may receive invitations to bid which may be declined or accepted and may send invitations to others when acting as the cedent which invitations may be accepted or declined by others. This is shown at step 728.

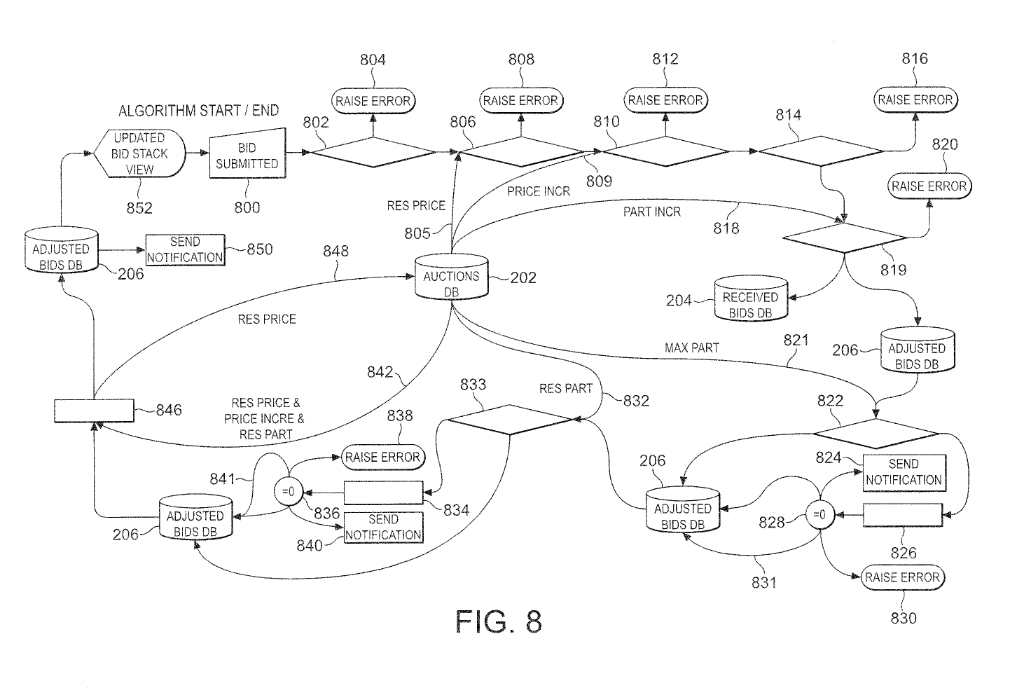

The above description explains how the auction process operates and how the auction price may vary transparently during the course of an auction. FIG. 8 shows the underlying technical process which enables the method described to be implemented on the computer system of FIG. 4. In FIG. 8, the auctions database, adjusted bids database, received bids database and administration database are identified by the same reference numerals as in FIG. 4.

The auctions database holds details of all auctions which have been entered into the system. This includes upcoming auctions, current auctions and past auctions as shown in FIG. 6. As well as storing details of the actual auction, the auctions database stores details of invitations sent, responses to invitations, access is granted, auction results, successful and unsuccessful bidders and documentation sent to successful bidders. The received bids database stores the details of each valid received bid, the bid having been validated according to the procedure described above. The adjusted bids database stores details of live bids for each open auction. These are the actual bids that will be accepted at the end of the auction when the auction window closes. The administration database stores the details of all potential users of the system, including their contact details, entity identification, user identification, contact details and system passwords.

From their auction display 210, the bidder can view the bid stack for a selected auction. The bid stack is provided from the adjusted bids database 206 and is a data table which shows the price, participation and relative submission time for bids with non-zero participation at a given time. The adjusted bids database, and the received bids database also, store the actual time of submission of bids, although this is not visible to bidders. The bid stack is dynamically updated in real time when submitted bids are validated using the method described above.

At step 800 in FIG. 8, a bidder submits a bid into the auction system using the bid participation, bid price and submit areas 308, 310 and 312 of their auction display as described in the illustration of FIG. 5. Under the system rules, once a bid has been submitted by a bidder and confirmed by the system it cannot be withdrawn. Although the bid may be signed down to zero, the bidder submitting a bid must be prepared to enter into a contract at that price for that participation.

After the bidder has clicked the bid button 312, the system server 200 sends a confirmation message back to the bidder asking them to confirm their bid. Given the binding nature of the bid, it is considered to be important to confirm the bidder's wishes. The bid data are transmitted to the system server and stored in the server memory 212. At step 802 the application checks whether the bid price is greater than zero. If not, the bid is rejected by the system server, an error is raised at step 804 and the bidder is sent a message from the system processor 209 for display at their terminal 210 informing them that the bid price is less than or equal to zero and therefore invalid. If the bid price is greater than zero, the application queries the auctions database 202 at step 805 and the database returns the reserve price associated with the auction and stores this data in the server memory of the auction system server. The application then checks if the bid price is less than or equal to the current reserve price at step 806. If the bid price is greater than the reserve price the bid is rejected by the application, an error is raised at step 808 and the bidder is sent a message from the system processor for display at their terminal informing them that the bid price is greater than the reserve price and therefore invalid.

If the bid price is less than or equal to the reserve price, the application running on the processor 209 queries the auctions database 202 at step 809 to return the price increment (price incr) associated with the auction and stores this data in the server memory 212. The bid price has to be an integer multiple of the price increment. In the illustration of FIG. 5, the price increment is set at 0.5%. At step 810, the application checks whether or not the remainder of the bid price divided by the price increment is zero.

If the remainder is not equal to zero, the application rejects the bid, raises an error at step 812 and sends a message from the server to the user terminal 210 informing the bidder that the bid price is not an integer multiple of the bid price increment and therefore invalid.

At step 814 having established that the remainder of the bid price divided by the price increment is zero, the application checks if the bid participation is greater than zero. If it is not greater than zero, the bid is rejected by the system server 200, an error is raised at step 816 and the bidder is sent a message from the system processor 209 for display at their terminal 210 informing them that the bid participation is less than or equal to zero and therefore invalid. If the participation is greater than zero, the application running on the processor queries the auctions database 202 at step 818 to return the participation increment (part incr) associated with the auction and stores this data in the server memory. In the example of FIG. 5, the minimum participation increment is set at $0.5 million requiring bidders to submit participations as multiples of $0.5 million. At step 819, the application checks whether or not the remainder of the bid participation divided by the participation increment is zero.

If the remainder is not equal to zero, the application rejects the bid, raises an error at step 820 and sends a message from the server 200 to the user terminal 210 informing the bidder that the bid participation is not an integer multiple of the participation increment and therefore invalid. This error message is displayed on the bidder's screen prompting the bidder to enter a fresh participation value. If the remainder of the bid participation divided by the participation increment is zero, the bid data are stored in the received bids database 204 and a copy of the same bid data is stored in the adjusted bids database 206. The bid data stored in the received bids database is a permanent record and is not adjusted further in any way. Any adjustment to the bid data that is required is applied to the copy of the bid data stored in the adjusted bids database. Thus, an original record of the received bid data is maintained in the received bids database, for example for audit purposes.

At step 821, the application queries the auctions database 202 to return the maximum participation (max part) for the bidder and stores this data in server memory 212. The cedent, prior to the auction, sets the maximum amount of participation that can be allocated to any given bidder. At step 822, the application queries the adjusted bids database 206 to return the sum of all prior bid participations for the bidder and stores this data in the server memory. The application checks whether or not the sum of the prior bid participations and the received bid participation is greater than the maximum participation.

If the sum is greater than the maximum participation then the participation of one or more of the bidder's bids in the adjusted bids database 206 is signed down. Bids are signed down from highest price to lowest price and, within price, from most recently received bid to least recently received bid. Signing down continues until the signed down sum is equal to the maximum participation. This step is formed at step 826. The received bid participation may or may not be signed down depending on its price and time of submission relative to the bidder's other bids. The adjusted bid is stored in the server memory 212 by the application running on processor 209.

If, at step 828, the received bid participation has been signed down and if the then adjusted bid participation value is zero, the application deletes the bid data from the adjusted bids database 206 without signing down any of the bidder's prior bids in same database. The application then raises and sends an error message to the bidder's terminal at step 830 informing the bidder that the maximum participation has been exhausted by prior bids. In this way, the bidder is notified that the received bid will no longer lead to a contract and may prompt the bidder to submit a fresh bid. If the received bid participation has been signed down and if the then adjusted bid participation value is greater than zero, the application overwrites the bid participation value in the adjusted bids database and stores the signed down bid participation values of the bidder's relevant prior bids in the same database at step 831. The application then raises and sends a notification at step 824 to the user terminal 210 to inform the bidder that the bid participation will be signed down as a result of the bidder's maximum participation restriction. The receipt of this message may prompt the bidder to reconsider submitting the bid and the bidder may choose to either submit the signed down bid or submit fresh bids. Note that whether or not the bid is deleted from the adjusted bids database or signed down, the received bids database stores the original bid data.

At step 832 the application queries the auctions database 202 to return the reserve participation (res part) for the auction and stores this data in the server memory 212. The application then queries the adjusted bids database 206 at step 833 to return the sum of all prior bid participations for the auction and stores this data in the server memory. The application checks whether or not the sum of the prior bid participations and the received bid participation is greater than the reserve participation.

If the sum is greater than the reserve participation, the participation of one or more bids in the adjusted bids database 206 is signed down. Bids are signed down from highest price to lowest price and, within price, from most recently received bid to least recently received bid. Signing down continues until the signed down sum is equal to the reserve participation. This step is performed at step 834. This received bid participation may or may not be signed down depending on its price and time of submission relative to all other bids.

If, at step 836, the received bid participation has been signed down and if the then adjusted bid participation value is zero, the application deletes the bid data from the adjusted bids database 206 without signing down any prior bids in the same database. The application then raises and sends an error message to the bidder's terminal at step 838 informing the bidder that the reserve participation has been exhausted by prior bids. In this way, the bidder is notified that their bid will no longer lead to a contract and may prompt the bidder to submit a fresh bid. If the received bid participation has been signed down and if the then adjusted bid participation value is greater than zero, the application overwrites the bid participation value in the adjusted bids database and stores the signed down bid participation values of the relevant prior bids in the same database at step 841. The application then raises and sends a notification at step 840 to the user terminal 210 to inform the bidder that the bid participation will be signed down as a result of the reserve participation restriction. The receipt of this message may prompt the bidder to reconsider submitting the bid and the bidder may choose to either submit the signed down bid or submit fresh bids.

At step 842 the application queries the auctions database 202 to return the reserve participation (res part) and the reserve price (res price) for the auction and stores this data in the server memory 212. The application then queries the adjusted bids database 206 at step 846 to return the sum of all bid participations for the auction and stores this data in the server memory. The application checks whether or not the sum of all bid participations is less than or equal to the reserve participation.

If the sum is less than the reserve participation then the reserve price remains unchanged since there is still participation available to bidders at prices lower than or equal to the current reserve price. If the sum is equal to the reserve participation then the current reserve price value is updated to the price of the bid at the highest price and, within price, the latest submitted bid, less the bid price increment. The updated reserve price is stored in the auctions database 202 at step 848.

The bid process is now complete and at step 850 the application running on processor 209 raises and sends a notification to the user terminal 210 across the communications network to the effect that the bid has been successfully submitted. At step 852, the processor updates the bid stack view 313 and communicates the new bid stack view comprising the content of the adjusted bids database 206 to the bidders' auction displays.

With the processing of the bid complete, the application is ready to receive the next and subsequent bids which are handled in the same manner as described.

At the end of the auction those bids which are stored in the adjusted bids database will be successful and contracts with bidders will be concluded in the known manner and as described above.

FIG. 9 illustrates in more detail the auction close process discussed above with respect to FIG. 5. The auction will close at a random time between a start and an end time that are displayed to the bidder on their screen. The purpose of the random auction close is to ensure that no participant, including the auction creators, will ever know exactly when the auction will end. This is done to prevent bidders withholding their bids until the very end of the auction and so ensure transparency. The system sets a minimum and maximum close time, and ends the auction at a random point between the two times. This is achieved by running a task periodically, for example every minute, which looks for all live auctions that have not yet ended and checking whether they are within their close window. For any auction that is within its close window a random number of seconds is generated which is less than or equal to the total number of seconds in the close window. This random number is compared with the number of seconds that have elapsed since the minimum close window and, if it is larger, the auction is ended.

Referring to FIG. 9, at the start of the process 910 the system determines that there is at least one auction in the system. On creating the auction, the Next Try step 920 has been set to the minimum end time of the auction ensuring that the Next Try step will be passed when the task is run for the first time. Next Try is a next time for testing whether the selected auction can be closed

At step 930 the system retrieves a list of all live auctions from the auctions database. An auction is considered to be live if the time of running the task is after the start of the auction and the auction has not been ended, cancelled or paused. At step 940 the list is examined to check whether it is empty. If it is empty the task is completed and the process waits until a predetermined time interval has passed, for example 1 minute before running the task again.

If the list is not empty the system picks one of the live auctions from the list and at step 920 checks whether NextTry is in the future. If it is, it is too soon to end the auction as the initial value of NextTry is the minimum close time. This ensures that the probability distribution is as uniform as possible with all seconds in the close window having the same chance of being picked. If next Try is in the future the process goes to step 9100, if it is in the past the process proceeds to step 960 in which a random time is chosen between the minimum and maximum end times. This may be achieved by converting the two times into numbers and picking a random number between the two. To convert a time to a number it is necessary to consider the number of ticks of that time, a tick being the smallest unit of time that is recognised by the computer.

Having generated the random number, at step 970, the system checks whether the random time is in the past. If it is, the auction is considered to be finished and the process goes to step 980 to end the auction. If the random end time Rend is in the future the auction should continue. The process then goes to step 990 where a fresh NextTry (step 920) value is generated and is set as another random time between the minimum and maximum end times.

Next, or if the auction has been ended (step 980), or NextTry has been determined to be in the future step 920), the auction is removed from the list at step 9100. This does not mean that the auction has ended, a new NextTry value may have been set.

At step 9110 the auction list is checked to determine whether there are any more auctions in the list. If so the process returns to step 950 for a new auction. If not, the process moves on to step 9120 to run the task again in the future. Step 9120 causes the process to wait for the predetermined period of time, after which it goes back to step 930 to rerun the task.

In the method and system described above, reinsurance contracts may be awarded via an auction process in which the auction algorithm ranks bids according to price and within price according to time of receipt. The bidders and the cedent may communicate with the auction system on-line or across a dedicated communications network using a standard Internet browser such as Microsoft Internet Explorer, Mozilla Firefox, Apple Safari etc. The participating bidders and cedent may use any suitable computing device such as desktop, laptop, mobile or tablet devices. The cedent, in combination with their broker, sets a reserve price and bidder's maximum participation restrictions at the beginning of the auction. Bidders can enter multiple bids at different prices and different participations although once submitted, a bid cannot be adjusted or withdrawn. The system is transparent in that bidders can see the prices and participations submitted by other bidders at bid level during an auction although they do not know the identity of other bidders. Where a participation restriction is exceeded, whether it is a bidder's maximum participation restriction or the reserve participation restriction, the algorithm signs down valid bids. Bids are also signed down in response to lower priced bids and based on a bid's position in the time order queue.

Many variants to the system and methods described are possible. In the reverse auction embodiment described, bidders compete for participation on a layer of reinsurance. The cedent is a passive participant in the auction. The cedent sets the initial reserve price and reserve participation for the auction and also sets the bidder-specific maximum participation for each invited bidder before the auction opens. During the auction the cedent can monitor the current reserve price, market price and market participation relative to the initial reserve price and the reserve participation but does not actively participate in or influence the outcome of the auction whilst the auction is live. Competition drives the price downward and at the end of the auction those bidders with the best (lowest) prices are allocated their bid participation. At the close of the auction the sum of bid participations may be less than or equal to the reserve participation. If the sum of bid participations is equal to the reserve participation then the layer of reinsurance has been fully placed. The intention of the mechanism is to allocate participation based on price, and is likely to identify the average price at which bidders are willing to provide reinsurance cover.

In a further embodiment of the invention, the concept of maximum participation is extended to the program level rather than just the auction level as described above. Program level maximum participation refers to the maximum participation permitted across a plurality of auctions that together comprise an auction program. Program level maximum participation requires that the bidder is constrained in the amount of participation they could bid for a particular auction and in the amount that they could bid for in aggregate across auctions in the same program. Thus a cedant can manage counterparty risk exposure from markets at both the auction level and the program or aggregate level.

In the example described with respect to FIG. 3 above, maximum participation is a market-specific, auction-specific parameter. In this embodiment it is a market-specific, auction-specific calculation which requires a market-specific, auction-specific maximum participation parameter and a market-specific, program-specific program maximum participation parameter. This may be expressed as follows:

Max participation_{B,A1.X}=(Auction Max Participation_{B,A1.x}−□Effective Participation_{B,A1.X,j}, Program Max Participation_{B,A1}−□□Effective Participation_{B,A1.i,j})
where
   A1 is the name of the program consisting of auctions A1.1, A1.2, . . . A1.X−1, A1.X, A1.X+1, . . . and
   (□ Effective Participation_{B,A1.i,j}) is the sum across all of bidder B's bids j=1, 2, 3, . . . in auction A1,i,j and
   (□ □ Effective Participation_{A1,i,j}) is the sum across all of bidder B's bids j=1, 2, 3, . . . across auctions i=A1.1, A1.2, A1.3, . . . , A1.X−1, A1.X+1, . . . .

The inclusion of program level maximum participation affects the sign down process described above. Suppose that two auctions (A1.1 and A1.2) both belong to the same program A1.

In this example Market B (Reinsurer B) has auction max participation parameters of $40 m and $50 m for the respective auctions. This means that Market B cannot bid for more than a $40 m limit and $50 m limit in each respective auction. In addition Market B has a program max participation parameters of $75 m_{[PL1]}. This means that Market B cannot bid for more than $75 m limit in aggregate across auctions A1.1 and A1.2.

Suppose that Market B has live bids for $30 m participation in auction A1.1 and $20 m participation in auction A1.2 then Market B cannot bid further for more than $25 m ($75 m−($20 m+$30 m)) across both auctions: Market B can bid for an additional $10 m in auction A1.1 and an additional $15 m in auction A1.2, or Market B can bid for an additional $0 m in auction A1.1 and an additional $25 m in auction A1.2, any combination of additional participations in the respective auctions satisfying all the restrictions.

If Market B is subsequently signed down in one or both auctions then the amount of unencumbered participation in the relevant auctions and in aggregate increases again.

It will therefore be appreciated that the maximum participation restriction in this embodiment is a calculation as opposed to a parameter. The maximum quantity in the example of FIG. 3 was defined as a parameter and set for each market, or bidder, for each auction that they were invited to. Different auctions can have different values for the parameter. The processor queries the auctions database and returns the maximum quantity for the bidder in the auction.

In this embodiment the maximum quantity is a calculation accepting two parameters which are set for each bidder for each auction to which they are invited; different auctions can have different values for the parameters. The processor queries the auctions database and return the necessary parameters so that the processor can calculate the maximum quantity for the bidder in the auction.

The first parameter is an auction level maximum quantity and may be expressed as a percentage of the limit being auctioned. This allows the cedent to control counterparty credit risk exposure for a specific auction. The second parameter is a program maximum quantity expressed as a nominal currency amount. This allows the cedent to control counterparty credit risk exposure across more than one auction. These two parameters are set by the cedent before the auction opens and the maximum participation restriction for the specific bidder-auction(s) combinations is calculated dynamically.

In this embodiment, the auction level max participation is a compulsory parameter but the program level max participation parameter is not enabling the cedent to choose not to manage counterparty credit risk across multiple auctions

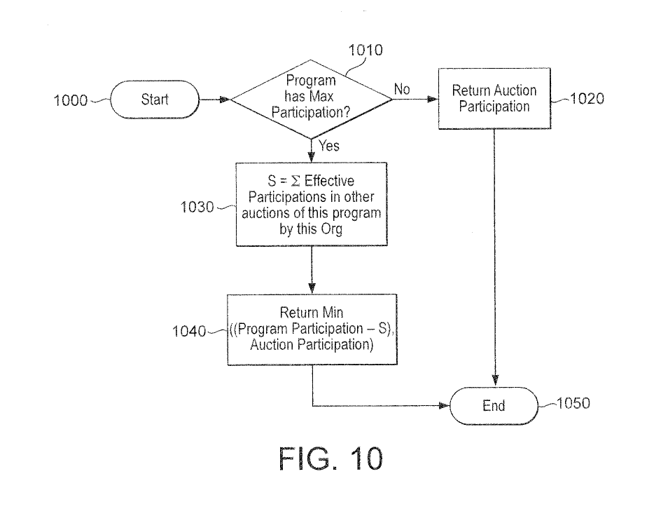

The modified sign down process including program level maximum participation will now be described with reference to FIG. 10. The process is started at step 1000 during the sign down process using data that is saved within the database. As step 1010 the process queries whether the program has maximum participation and so determines whether maximum participation is based on just the auction or on the auction and the program. If there is no maximum participation set for the present program the process proceeds to step 1020 and participation is limited to the maximum participation indication on the invitation to the auction. This value is the Max Participation value referred to with respect to FIG. 3.

If step 1010 indicates that there is maximum program participation the process goes to step 1030 where a variable S is determined that is the sum of participation used by a bidder. As multiple auctions my run concurrently, the value of S is determined by placing each bid.

At step 1040 the value of S is used to return Min((Program Participation−S), Auction Participation). There are two limitations on a bidder: the program level limitation determined by the remaining Max Participation based on the participation used in other auctions, and Auction level limitation determined on the invitation and set for each auction-bidder pair. The process ensures that bidders do not exceed any of these limitation. Thus this step returns the minimum value between the auction level and the remaining participation of program level. The process then ends at step 1050.

In an alternative embodiment, the auction is two way. Bidders still compete for participation on a layer of reinsurance. However, in this embodiment the cedent is an active participant in the auction. The cedent sets the reserve participation for the auction and also sets the bidder-specific maximum participation for each invited bidder before the auction opens. In addition to this the cedent also makes a single price offer for the full reserve participation prior to the start of the auction and the offer stands for the duration of the auction. While the auction is live, bidders can submit bids and lift the cedent offer, in which case they elect to transact at the cedent's offer price. The cedent can also hit submitted bids, in which case they elect to transact at the cedent's offer price. Thus, in this embodiment, the cedent can influence the outcome of the auction and this embodiment results in participation being allocated to bidders during the auction as opposed to at the end of the auction. In this embodiment the cedent can choose how much participation to place and at what price, subject to the available bids at a given time in the auction. In turn the bidder can amend bid participation downward and retract submitted bids. At the close of the auction the sum of bid participations allocated during the auction may be less than or equal to the reserve participation. If the sum of bid participations is equal to the reserve participation then the layer of reinsurance has been fully placed and the auction closes immediately.

The aim of this alternative embodiment is to allocate participation based on price, and it is likely to identify the average price at which the cedent and bidders are willing to transact reinsurance cover.

Thus, two-way mechanism enables a plurality of bidders and a single offerer (the cedent).

In the embodiments described, the auctioneer, that is the system operator, can see the identities of all bidders but bidders are anonymous to one another at all times and are anonymous to the cedent during the auction. This is highly desirable as it prevents interference in the auction process either by bidders or by the cedent. Once the auction is completed, only successful bidders can see who else has been successful as well as their allocated participations. However, no bidder can ever see another bidder's weighted average bid price. Once the auction is completed, the cedent can also see who has been successful as well as their allocated participations. In addition to this, the cedent can also see the weighted average bid price payable to each successful bidder once the auction is completed.

Although the auction process involves individual bids being signed down as they lose their place at the top of the auction through being outbid, bidders are aware of the signing down that is happening to their bids so allowing them to submit new bids to maintain their desired participation.

Preferred embodiments described support multiple prices for multiple reinsurers, multi-round multi-price electronic bidding in real time and a completely transparent signing down mechanism based on price-time priority.

Many other modifications and variations to the system and methods described are possible and will occur to those skilled in the art without departing from the spirit and scope of the invention which is defined by the following claims.

1. A computerised method of auctioning reinsurance capacity, the method performed by an auction server computer system communicating with a cedent computer and a plurality of bidder computers via a communications network, the server computer system comprising a processor, a memory, a received bids database, an auctions database; an adjusted bids database and an administration database; the method comprising the steps of:
receiving at the server computer system bids from bidder computers to participate in a reinsurance auction, the auction having a predetermined reserve price and reserve quantity and each bid comprising a bid price and a bid quantity at that price;
validating the received bids at the server computer system and storing validated bids in the received bids database and the adjusted bids database of the computer system in order of time of receipt;
for each received bid, comparing the sum of quantities of prior received bids and the received bid with the reserve quantity of the auction;
if the sum of quantities is greater than the reserve quantity, signing down the quantity of one or more of the received bids and prior received bids according to a price priority and, for each price, according to a time of receipt priority so that the sum of quantities of the prior received bids and the received bid is equal to the reserve quantity;
after the step of comparing, overwriting the quantity of signed down received or prior received bids in the adjusted bids database; and
at the end of the auction, concluding reinsurance contracts with bids remaining in the adjusted bids database.

2. A computerised method according to claim 1, wherein the step of signing down bids comprises removing from the adjusted bids database any bid having a signed down quantity of zero.

3. A computerised method according to claim 1, wherein the step of storing a signed down bid in the adjusted bids database comprises removing the bid from the database if the signed down quantity of the bid is zero.

4. A computerised method according to claim 1, comprising, prior to the step of receiving bids, sending an invitation to selected bidder computers to participate in a forthcoming auction, the invitation identifying the reinsurance contract to be auctioned and the start time of the auction.

5. A computerised method according to claim 1, comprising receiving from one or more bidder computers, acceptance of the invitation to participate in the forthcoming auction.

6. A computerised method according to claim 1, comprising sending periodically to participating bidder computers for display details of live bids stored in the adjusted bids database including the price and quantity of bids.

7. A computerised method according to claim 6, wherein the details of live bids include the position in a queue for each displayed bid, the queue comprising bids at the same price and being ranked in order of time of receipt of the bid at the auction server computer.

8. A computerised method according to claim 6 wherein the details of the live bids sent for display are anonymous as to the identity of the party submitting the bid.

9. A computerised method according to claim 1, wherein each bidder has a pre-determined maximum quantity biddable in the auction, comprising comparing the sum of quantities of the bidder's prior bids and the received bid with the maximum quantity, and if the sum of quantities of the received bid and the bidder's prior bids is greater than the maximum quantity, signing down the bid quantity of one or more of the prior bids or the received bid so that the sum of quantities for all of the bidder's bids is equal to the maximum quantity, bids being signed down according to a price priority and, for each price, according to a time of receipt priority.

10. A computerised method according to claim 1, wherein each bidder has a pre-determined maximum quantity biddable in the auction, and a pre-determined maximum quantity biddable in an auction program comprising a plurality of auctions including the auction, comprising comparing the sum of quantities of the bidder's prior bids in the auction and the received bid with the maximum auction quantity, comparing the sum of quantities of the bidder's prior bids in auctions comprising the auction program, and if the sum of quantities of the received bid and the bidder's prior bids is greater than the auction maximum quantity or the sum of the quantities of the prior bids in auctions comprising the auction program and the received bid is greater than the maximum quantity biddable in the auction program, signing down the bid quantity of one or more of the prior bids or the received bid so that the sum of quantities for all of the bidder's bids is equal to the maximum auction quantity and the maximum auction program quantity, bids being signed down according to a price priority and, for each price, according to a time of receipt priority.

11. A computerised method according to claim 1, wherein the termination time of the auction is variable between an earliest auction close time and a latest auction close time, the actual close time being determined by the auction server computer.

12. A computerised method according to claim 11, wherein the auction server computer retrieves a list of live auctions from the auctions database, selects an auction from the auction database, determines whether a next time for testing if the selected auction can be closed, has been reached, the next time for testing being set initially to the earliest auction close time, if the next time for testing has been reached, choosing a random close time between the earliest auction close time and the latest auction close time, determining whether that random close time is in the past and, if it is in the past, closing the auction.

13. A computerised method according to claim 12, wherein if the random close time is determined not to be in the past, setting the next time for testing as another random time between the earliest auction close time and the latest auction close time.

14. A computerised method according to claim 12, further comprising determining whether the list of live auctions includes any further auctions and, if there are further live auctions, selecting a further auction from the live auction database.

15. A computerised method according to claim 14, comprising, if there are no further live auctions, waiting for a predetermined period of time and then retrieving a list of live auctions from the auctions database.

16. A computerised method according to claim 11, wherein the earliest auction close time and the latest auction close time are communicated to bidder computers for display.

17. A computerised method according to claim 16, comprising receiving multiple bids from a given bidder during an auction.

18. A computerised method according to claim 1, wherein a bid received from a bidder is binding on the bidder.

19. A computerised method according to claim 18, comprising receiving at the auction server computer an amended bid having one or both or a lower price and a greater quantity

20. A computerised method according to claim 1, comprising, after storing the one or more signed down bids in the adjusted bids database, determining from the bids stored in the adjusted bids database whether the sum of quantities for bids at or below a given price is equal to the reserve quantity and, if so, updating the reserve price for the auction.

21. A computerised method according to claim 20, wherein the updated reserve price is equal to the lowest price having the sum of quantities for bids at or below that price equal to the reserve quantity, less the predetermined price increment.

22. A computerised method according to claim 1, wherein the step of validating bids comprises determining whether the bid price is less than or equal to the reserve price and notifying the bidder if the bid price is not less than or equal to the reserve price.

23. A computerised method according claim 1, comprising, after validation of a bid, storing the bid in the received bids database and the adjusted bids database, wherein the step of storing the signed down bid in the adjusted bids database comprises replacing the received bid in the adjusted bids database with the signed down bid.

24. A computerised method according to claim 9, wherein the step of comparing the sum of quantities for the bidder's prior bids and the received bid with the bidder's maximum quantity comprises:
querying the auctions database to return the maximum quantity for the bidder in the auction;
storing the returned maximum quantity in a memory of the server computer system;
querying the adjusted bids database to return the sum of all prior bids from the bidder for the auction at the same or better prices;
storing the returned sum of all prior bids in the memory;
the processor summing the stored sum of all prior bids' quantity and the bid quantity and determining whether the sum is greater than said maximum quantity;
if said sum is greater, the processor further signing down the bid quantity of one or more of the prior bids or the received bid so that the sum of quantities for all of the bidder's bids is equal to the maximum quantity;
bids being signed down according to a price priority and, for each price, according to a time of receipt priority;
deleting bids from the adjusted bids database having signed down quantities equal to zero; and
overwriting quantities for bids in the adjusted bids database having signed down quantities greater than zero.

25. A computerised method according to claim 24, comprising the processor notifying the bidder computer if the bid is deleted or signed down.

26. A computerised method according to claim 25, wherein the notification includes the reason for the bid being signed down and the value of the signed down quantity.

27. A computerised method according to claim 1, wherein:
comparing the sum of quantities of the prior bids and the received bid with the auction's reserve quantity of the auction comprises the processor querying the auctions database to return the reserve quantity and storing the returned reserve quantity in said memory; and
signing down the bid quantity comprises:
querying the adjusted bids database to return the sum of quantities for all prior bids in the auction and storing the sum returned in said memory;
determining whether the sum of quantities for all prior bids and the received bid is greater than the reserve quantity; and
if the sum is greater, signing down the quantity of one or more bids so that the sum of quantities is equal to the reserve quantity;
bids being signed down according to a price priority and, for each price, according to a time of receipt priority.

28. A computerised method according to claim 1, comprising, after the step of storing the signed down bid in the adjusted bids database, sorting bid records in the adjusted bids database in ascending order of price and ascending order of time of receipt at the server computer system within price.

29. A computerised auction system for auctioning reinsurance capacity, the auction system comprising a server computer system and program code running on the server computer system, the server computer system communicating with a cedent computer and a plurality of bidder computers via a communications network, the server computer system comprising:
a processor;
a memory;
a received bids database;
an auctions database;
an adjusted bids database; and
an administration database;
the program code, when executed on the processor causing the server computer system to perform the steps of:
receive bids from said bidder computers to participate in a reinsurance auction, the auction having a predetermined reserve price and reserve quantity and each bid comprising a bid price and a bid quantity at that price;
validate the received bids;
store validated bids in the received bids database and the adjusted bids database of the computer system in order of time of receipt;
for each received bid, compare the sum of quantities of prior received bids and the received bid with the reserve quantity of the auction;
if the sum of quantities is greater than the reserve quantity, sign down the quantity of one or more of the received bids and prior received bids according to a price priority and, for each price, according to a time of receipt priority, so that the sum of quantities of the prior received bids and the received bid is equal to the reserve quantity;
after the step of comparing, overwrite the quantity of signed down received or prior received bids in the adjusted bids database; and
at the end of the auction, concluding reinsurance contracts with bids remaining in the adjusted bids database.

30. A computerised auction system according to claim 29, wherein in performing the step of signing down bids in the adjusted bids database, the program code causes the processor to remove from the adjusted bids database any bid having a signed down quantity of zero.

31. A computerised auction system according to claim 29, wherein in performing the step of storing a signed down bid in the adjusted bids database, the program code causes the processor to remove the bid from the database if the signed down quantity of the bid is zero.

32. A computerised auction system according to claim 29, wherein the program code causes the processor, prior to the step of receiving bids, to send an invitation to selected bidder computers to participate in a forthcoming auction, the invitation identifying the reinsurance contract to be auctioned and the start time of the auction.

33. A computerised auction system according to claim 29, wherein the program code causes the server computer system to receive from one or more bidder computers, acceptance of the invitation to participate in the forthcoming auction.

34. A computerised auction system according to claim 29, wherein the program code causes the server computer to send periodically to participating bidder computers for display, details of live bids stored in the adjusted bids database including the price and quantity of bids.

35. A computerised auction system according to claim 34, wherein the details of live bids include the position in a queue for each displayed bid, the queue comprising bids at the same price and being ranked in order of time of receipt of the bid at the auction server computer.

36. A computerised auction system according to claim 34, wherein the details of the live bids sent for display are anonymous as to the identity of the party submitting the bid.

37. A computerised auction system according to claim 29, wherein each bidder has a pre-determined maximum quantity in the auction, wherein the program code further causes the processor to compare the sum of quantities of the bidder's prior bids and the received bid with the maximum quantity, and if the sum of quantities of the received bid and the bidder's prior bids is greater than the maximum quantity, to sign down the bid quantity of one or more of the prior bids or the received bid so that the sum of quantities for all of the bidder's bids is equal to the maximum quantity, bids being signed down according to a price priority and, for each price, according to a time of receipt priority.

38. A computerised auction system according to claim 29, wherein each bidder has a pre-determined maximum quantity biddable in the auction, and a pre-determined maximum quantity biddable in an auction program comprising a plurality of auctions including the auction, comprising comparing the sum of quantities of the bidder's prior bids in the auction and the received bid with the maximum auction quantity, comparing the sum of quantities of the bidder's prior bids in auctions comprising the auction program, and if the sum of quantities of the received bid and the bidder's prior bids, is greater than the auction maximum quantity or the sum of the quantities of the prior bids in auctions comprising the auction program and the received bid is greater than the maximum quantity biddable in the auction program, signing down the bid quantity of one or more of the prior bids or the received bid so that the sum of quantities for all of the bidder's bids is equal to the maximum auction quantity and the maximum auction program quantity, bids being signed down according to a price priority and, for each price, according to a time of receipt priority.

39. A computerised auction system according to claim 29, wherein the program code causes the processor to select a termination time of the auction between an earliest auction close time and a latest auction close time.

40. A computerised auction system according to claim 39, wherein program code causes the auction server computer to retrieve a list of live auctions from the auctions database, select an auction from the auction database, determine whether a next time for testing whether the selected auction can be closed, has been reached, the next time for testing being set initially to the earliest auction close time, if the next time for testing has been reached, choose a random close time between the earliest auction close time and the latest auction close time, determine whether that random close time is in the past and, if it is in the past, close the auction.

41. A computerised auction system according to claim 40, wherein if the random close time is determined not to be in the past, the program codes causes the next time for testing to be set as another random time between the earliest auction close time and the latest auction close time.

42. A computerised auction system according to claim 40, further comprising the program code determining whether the list of live auctions includes any further auctions and, if there are further live auctions, causing a further auction to be selected from the live auction database.

43. A computerised auction system according to claim 42, comprising, if there are no further live auctions, the program code causing the processor to wait for a predetermined period of time and then retrieving a list of live auctions from the auctions database.

44. A computerised auction system according to claim 39, wherein program code causes the earliest auction close time and the latest auction close time to be communicated to bidder computers for display.

45. A computerised auction system according to claim 29, wherein the server system is configured to receive multiple bids from a given bidder during an auction.

46. A computerised auction system according to claim 29, wherein a bid received from a bidder is binding on the bidder.

47. A computerised auction system according to claim 46, wherein the program code causes the server computer to receive an amended bid for a bidder computer having one or both or a lower price and a greater quantity.

48. A computerised auction system according to claim 29, wherein the program code causes the processor, after storing the one or more signed down bids in the adjusted bids database, to determine from the bids stored in the adjusted bids database whether the sum of quantities for bids at or below a given price is equal to the reserve quantity and, if so, update the reserve price for the auction.

49. A computerised auction system according to claim 48, wherein the updated reserve price is equal to the lowest price having the sum of quantities for bids at or below that price equal to the reserve quantity, less the predetermined price increment.

50. A computerised auction system according to claim 29, wherein in performing the step of validating bids the program code causes the processor to determine whether the bid price is less than or equal to the reserve price and notify the bidder if the bid price is not less than or equal to the reserve price.

51. A computerised auction system according claim 29, wherein the program code causes the processor, after validation of a bid, to store the bid in the received bids database and the adjusted bids database, wherein in performing the step of storing the signed down bid in the adjusted bids database the program code causes the processor to replace the received bid in the adjusted bids database with the signed down bid.

52. A computerised auction system according to claim 38, wherein in performing the step of comparing the sum of quantities for the bidder's prior bids and the received bid with the bidder's maximum quantity the program code causes the processor to perform the steps of:
querying the auctions database to return the maximum quantity for the bidder in the auction;
storing the returned maximum quantity in a memory of the server computer system;
querying the adjusted bids database to return the sum of all prior bids from the bidder for the auction at the same or better prices;
storing the returned sum of all prior bids in the memory;
summing the stored sum of all prior bids' quantity and the bid quantity and determining whether the sum is greater than said maximum quantity;
if said sum is greater, further signing down the bid quantity of one or more of the prior bids or the received bid so that the sum of quantities for all of the bidder's bids is equal to the maximum quantity;
bids being signed down according to a price priority and, for each price, according to a time of receipt priority.

53. A computerised auction system according to claim 52, wherein the program code causes the processor to notify the bidder computer if the received bid is deleted or signed down.

54. A computerised auction system according to claim 53, wherein the notification includes the reason for the bid being signed down and the value of the signed down quantity

55. A computerised auction system according to claim 29, wherein:
In performing the step of comparing the sum of quantities for the prior bids and the received bid with the reserve quantity of the auction the program code causes the processor to query the auctions database to return the reserve quantity and to store the returned reserve quantity in said memory; and
in performing the step of signing down the bid quantity the program code causes the computer to perform the steps of:
querying the adjusted bids database to return the sum of all prior bids quantity in the auction and storing the sum returned in said memory;
determining whether the sum of quantities for all prior received bids and the received bid is greater than the reserve quantity; and
if the sum is greater, signing down the quantity of one or more bids so that the sum of quantities is equal to the reserve quantity, bids being signed down according to a price priority and, for each price, according to a time of receipt priority.

56. A computerised auction system according to claim 29, wherein the program code causes the processor, after the step of storing the signed down bid in the adjusted bids database, to sort bid records in the adjusted bids database in ascending order of price and ascending order of time of receipt at the server computer system within a given price.

57. A computerised method of auctioning reinsurance capacity, the method performed by an auction server computer system communicating with a cedent computer and a plurality of bidder computers via a communications network, the server computer system comprising a processor, a memory, a received bids database, an auctions database; an adjusted bids database and an administration database; the method comprising the steps of:
receiving at the server computer system bids from bidder computers to participate in a reinsurance auction, the auction having a predetermined reserve price and reserve quantity and each bid comprising a bid price and a bid quantity at that price;
validating the received bids at the server computer system and storing validated bids in the received bids database and the adjusted bids database of the computer system in order of time of receipt;
for each received bid, comparing the sum of quantities of prior received bids and the received bid with the reserve quantity of the auction;
if the sum of quantities is greater than the reserve quantity, signing down the quantity of one or more of the received bids and prior received bids according to a price priority and, for each price, according to a time of receipt priority so that the sum of quantities of the prior received bids and the received bid is equal to the reserve quantity, wherein the step of signing down bids comprises removing from the adjusted bids database any bid having a signed down quantity of zero;
after the step of comparing, overwriting the quantity of signed down received or prior received bids in the adjusted bids database, the overwriting comprising removing the bid from the database if the signed down quantity of the bid is zero; and
at the end of the auction, concluding reinsurance contracts with bids remaining in the adjusted bids database, wherein the termination time of the auction is variable between an earliest auction close time and a latest auction close time, the actual close time being determined by the auction server computer retrieving a list of live auctions from the auctions database, selecting an auction from the auction database, determining whether a next time for testing if the selected auction can be closed has been reached, the next time for testing being set initially to the earliest auction close time, if the next time for testing has been reached, choosing a random close time between the earliest auction close time and the latest auction close time, determining whether that random close time is in the past and, if it is in the past, closing the auction, wherein if the random close time is determined not to be in the past, setting the next time for testing as another random time between the earliest auction close time and the latest auction close time, determining whether the list of live auctions includes any further auctions and, if there are further live auctions, selecting a further auction from the live auction database, and if there are no further live auctions, waiting for a predetermined period of time and then retrieving a list of live auctions from the auctions database.

58. A computerised auction system for auctioning reinsurance capacity, the auction system comprising a server computer system and program code running on the server computer system, the server computer system communicating with a cedent computer and a plurality of bidder computers via a communications network, the server computer system comprising:
a processor;
a memory;
a received bids database;
an auctions database;
an adjusted bids database; and
an administration database;
the program code, when executed on the processor causing the server computer system to perform the steps of:
receive bids from said bidder computers to participate in a reinsurance auction, the auction having a predetermined reserve price and reserve quantity and each bid comprising a bid price and a bid quantity at that price;
validate the received bids;
store validated bids in the received bids database and the adjusted bids database of the computer system in order of time of receipt;
for each received bid, compare the sum of quantities of prior received bids and the received bid with the reserve quantity of the auction;
if the sum of quantities is greater than the reserve quantity, sign down the quantity of one or more of the received bids and prior received bids according to a price priority and, for each price, according to a time of receipt priority, so that the sum of quantities of the prior received bids and the received bid is equal to the reserve quantity, wherein in performing the step of signing down bids in the adjusted bids database, the program code causes the processor to remove from the adjusted bids database any bid having a signed down quantity of zero;
after the step of comparing, overwrite the quantity of signed down received or prior received bids in the adjusted bids database, wherein in performing the step of overwriting a signed down bid in the adjusted bids database, the program code causes the processor to remove the bid from the database if the signed down quantity of the bid is zero; and
at the end of the auction, concluding reinsurance contracts with bids remaining in the adjusted bids database, wherein the program code causes the processor to select a termination time of the auction between an earliest auction close time and a latest auction close time, and causes the auction server computer to retrieve a list of live auctions from the auctions database, select an auction from the auction database, determine whether a next time for testing whether the selected auction can be closed, has been reached, the next time for testing being set initially to the earliest auction close time, if the next time for testing has been reached, choose a random close time between the earliest auction close time and the latest auction close time, determine whether that random close time is in the past and, if it is in the past, close the auction, wherein if the random close time is determined not to be in the past, the program codes causes the next time for testing to be set as another random time between the earliest auction close time and the latest auction close time, wherein the program code further determines whether the list of live auctions includes any further auctions and, if there are further live auctions, causes a further auction to be selected from the live auction database, and if there are no further live auctions, the program code causes the processor to wait for a predetermined period of time and then retrieving a list of live auctions from the auctions database.
